(19) United States
(12) Patent Application Publication
(10) Pub. No.: US 2026/0230017 A1
(43) Pub. Date: Aug. 6, 2026

(54) SYSTEMS, METHODS, AND INTEGRATED CIRCUITS FOR DYNAMICALLY ADJUSTING INTEGRATION WINDOW FOR MOTOR RESOLVER DECODER

(71) Applicant: STMicroelectronics International N.V., Geneva (CH)

(72) Inventors: Jian WANG, Shanghai (CN); Charles AUBENAS, Paris (FR); Luting YE, Shanghai (CN); Xiaobo SUN, Shanghai (CN); Shisheng LIANG, Shanghai (CN)

(21) Appl. No.: 19/046,149

(22) Filed: Feb. 5, 2025

(51) Int. Cl. H02P 21/18; H02P 25/022

(52) U.S. Cl. CPC H02P 21/18; H02P 25/022; H02P 2203/11

(57) ABSTRACT

In accordance with various embodiments of the present disclosure, an integrated circuit for determining a start time of an integration window of a motor resolver is provided. In some embodiments, the integrated circuit comprises a timer module for repeatedly determining a plurality of timer values, each timer value corresponding to an elapsed time between a zero crossing of an exciting signal provided to a resolver of an electric motor and a corresponding immediately succeeding zero crossing of a feedback signal from the resolver; a filter module for repeatedly determining, based on a most recent sub-plurality of the timer values, a compensation time corresponding to a delay between the exciting signal and the feedback signal; and an integration module for repeatedly determining a start time of an integration window by adding a most recently determined compensation time to a time of a most recent zero crossing of the exciting signal.

### FIELD OF THE INVENTION

Example embodiments of the present disclosure relate generally to electric motors and, more particularly, to integrated circuits, processing systems, and methods for determining an angular position of an electric motor.

### BACKGROUND

In electric motor control applications, it is often necessary to know the angular position (or, simply, the angle) of the motor's rotor, such as to accurately control the torque of the motor. This angle may be designated as θ (theta). One conventional method of determining the angular position of the motor's rotor is to use a resolver coupled to the motor. A resolver is a device having a rotating winding that is excited with a high-frequency signal (the high-frequency signal provided to the resolver is termed an “exciting signal”) and two stationary windings positioned at 90 degrees to each other. When the motor is rotating, electric current flows through the rotating winding which induces current in the stationary, two-phase windings. The two two-phase windings, being positioned at 90 degrees to each other, produce a sine and cosine feedback current. The relative amplitudes of the two-phase voltages are measured and used to determine the angle of the rotor relative to the stator. The angle can be computed using “arctangent” function, phase locked loops, or other known techniques.

Several components used in electric motor control applications introduce a phase delay between the exciting signal and the resolver signal (i.e., the sine and cosine signals). This phase delay must be compensated for to obtain an accurate rotor angle determination. Determining the rotor angle requires selecting an integration window for the sine and cosine resolver signals, and the phase delay must be accurately determined to select the correct integration window. However, determining and compensating for this phase delay is difficult because the phase delay changes over time, particularly due to changing temperature.

Applicant has identified many technical challenges and difficulties associated with compensating for a phase delay between an exciting signal and a resolver signal when determining the angular position of an electric motor. Through applied effort, ingenuity, and innovation, Applicant has solved problems related to compensating for a phase delay between an exciting signal and a resolver signal when determining the angular position of an electric motor by developing solutions embodied in the present disclosure, which are described in detail below.

### BRIEF SUMMARY

Various embodiments described herein related to integrated circuits, processing systems, and methods for determining a start time of an integration window of a motor resolver.

In accordance with various embodiments of the present disclosure, an integrated circuit for determining a start time of an integration window of a motor resolver is provided. In some embodiments, the integrated circuit comprises a timer module for repeatedly determining a plurality of timer values, each timer value corresponding to an elapsed time between a zero crossing of an exciting signal provided to a resolver of an electric motor and a corresponding immediately succeeding zero crossing of a feedback signal from the resolver; a filter module for repeatedly determining, based on a most recent sub-plurality of the timer values, a compensation time corresponding to a delay between the exciting signal and the feedback signal; and an integration module for repeatedly determining a start time of an integration window by adding a most recently determined compensation time to a time of a most recent zero crossing of the exciting signal.

In some embodiments, the integrated circuit further comprises a comparator module for continuously determining an amplitude of a sine component of the feedback signal and a cosine component of the feedback signal and continuously producing a sampled feedback signal using the sine component when the amplitude of the sine component is larger than the amplitude of the cosine component and using the cosine component when the amplitude of the cosine component is larger than the amplitude of the sine component. The timer module uses the sampled feedback signal to identify zero crossings of the feedback signal and determine the plurality of timer values.

In some embodiments, the integrated circuit further comprises an analog-to-digital converter module to receive the feedback signal from the resolver and provide a digital version of the sine component and a digital version of the cosine component to the comparator module.

In some embodiments, the integration module repeatedly determines a rotor angle within each integration window.

In some embodiments, the filter module comprises a finite impulse response (FIR) filter.

In some embodiments, the FIR filter comprises 25 taps.

In accordance with various embodiments of the present disclosure, a processing system for determining a start time of an integration window of a motor resolver is provided. In some embodiments, the processing system comprises a timer module for repeatedly determining a plurality of timer values, each timer value corresponding to an elapsed time between a zero crossing of an exciting signal provided to a resolver of an electric motor and a corresponding immediately succeeding zero crossing of a feedback signal from the resolver; a filter module for repeatedly determining, based on a most recent sub-plurality of the timer values, a compensation time corresponding to a delay between the exciting signal and the feedback signal; and an integration module for repeatedly determining a start time of an integration window by adding a most recently determined compensation time to a time of a most recent zero crossing of the exciting signal.

In accordance with various embodiments of the present disclosure, a method for determining a start time of an integration window of a motor resolver is provided. In some embodiments, the method comprises repeatedly determining a plurality of timer values, each timer value corresponding to an elapsed time between a zero crossing of an exciting signal provided to a resolver of an electric motor and a corresponding immediately succeeding zero crossing of a feedback signal from the resolver; repeatedly determining, based on a most recent sub-plurality of the timer values, a compensation time corresponding to a delay between the exciting signal and the feedback signal; and repeatedly determining a start time of an integration window by adding a most recently determined compensation time to a time of a most recent zero crossing of the exciting signal.

The above summary is provided merely for purposes of summarizing some example embodiments to provide a basic understanding of some aspects of the disclosure. Accordingly, it will be appreciated that the above-described embodiments are merely examples and should not be construed to narrow the scope or spirit of the disclosure in any way. It will also be appreciated that the scope of the disclosure encompasses many potential embodiments in addition to those here summarized, some of which will be further described below.

### BRIEF DESCRIPTION OF THE DRAWINGS

The description of the illustrative embodiments may be read in conjunction with the accompanying figures. It will be appreciated that, for simplicity and clarity of illustration, elements illustrated in the figures have not necessarily been drawn to scale, unless described otherwise. For example, the dimensions of some of the elements may be exaggerated relative to other elements, unless described otherwise. Embodiments incorporating teachings of the present disclosure are shown and described with respect to the figures presented herein, in which:

FIG. 1 is an example block diagram illustrating an example system for determining a start time of an integration window of a motor resolver, in accordance with some embodiments of the present disclosure;

FIG. 2 illustrates an example motor resolver feedback signal, in accordance with some embodiments of the present disclosure;

FIG. 3 illustrates an example event timeline of an example system for determining a start time of an integration window of a motor resolver, in accordance with some embodiments of the present disclosure; and

FIG. 4 is an example flow diagram illustrating an example method for determining a start time of an integration window of a motor resolver, in accordance with an example embodiment of the present disclosure.

### DETAILED DESCRIPTION OF THE INVENTION

Some embodiments of the present disclosure will now be described more fully hereinafter with reference to the accompanying drawings, in which some, but not all embodiments of the disclosure are shown. Indeed, these disclosures may be embodied in many different forms and should not be construed as limited to the embodiments set forth herein; rather, these embodiments are provided so that this disclosure will satisfy applicable legal requirements. Like numbers refer to like elements throughout.

As used herein, terms such as “front,” “rear,” “top,” etc. are used for explanatory purposes in the examples provided below to describe the relative position of certain components or portions of components. Furthermore, as would be evident to one of ordinary skill in the art in light of the present disclosure, the terms “substantially” and “approximately” indicate that the referenced element or associated description is accurate to within applicable engineering tolerances.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

Various embodiments of the present disclosure overcome the above technical challenges and difficulties and provide various technical improvements and advantages based on, for example, but not limited to, providing example integrated circuits, processing systems, and methods for determining a start time of an integration window of a motor resolver. Various embodiments of the present disclosure are used with three phase or multiphase electric motors that have resolvers for detecting rotor angle, such as but not limited to Permanent Magnet Synchronous Motors (PMSM).

Various embodiments of the present disclosure involve dynamically determining a phase delay between a resolver exciting signal and the resolver sine and cosine feedback signals in order to accurately determine an integration window and therefore accurately determine a rotor angle.

In various embodiments, the zero crossing points of the sine and cosine components of the resolver feedback signal are determined (the sine and cosine feedback signals are in phase and therefore have the same zero crossing points) based on which signal component (sine or cosine) has the greater amplitude at each point in time and generating a sampled feedback signal corresponding to the zero crossing points of the sine component when its amplitude is greater and to the zero crossing points of the cosine component when its amplitude is greater. In various embodiments, a timer is started at each zero crossing of the exciting signal and stopped at each corresponding zero crossing of the sampled feedback signal. In various embodiments, a most recently preceding plurality of timer values is filtered to obtain a time compensation value corresponding to the phase delay between the exciting signal and the resolver feedback signal. In various embodiments, the time compensation value is added to the time of the most recent zero crossing of the exciting signal to determine the start time of the integration window for calculating the rotor angle.

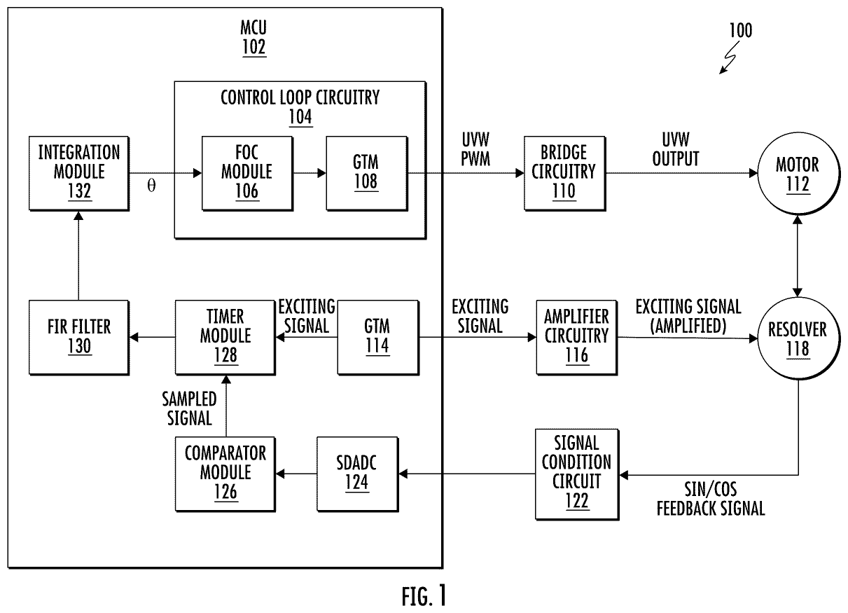

Referring now to FIG. 1, an example block diagram illustrating an example system for determining a start time of an integration window of a motor resolver is illustrated in accordance with an example embodiment of the present disclosure. In the illustrated embodiment, the example system 100 comprises a microcontroller (MCU) 102 functioning as a motor control unit controlling a motor 112 having a resolver 118. The MCU 102 comprises control loop circuitry 104, which in turn comprises a field-oriented control (FOC) module 106 and a generic timer module (GTM) 108. The MCU 102 further comprises another GTM 114, an analog-to-digital converter (e.g., a Sigma-Delta ADC (SDADC)) 124, a comparator module 126, a timer module 128, a filter (e.g., a finite impulse response (FIR) filter), and an integration module 132.

The modules of the control loop circuitry 104 work together to receive the rotor angle θ and output a PWM signal (labeled UVW PWM) for each of the three phases (U, V, W) of the motor 112 to control the operation of the motor 112. The PWM signal is provided to a bridge circuitry 110, such as an H-bridge, which provides a UVW output to the motor 112. In various embodiments, the bridge circuitry 110 is like a pre-driver which can increase the 0~5V level PWM signal as needed.

In the illustrated example, the GTM 114 generates an exciting signal (e.g., a 10 kHz signal) which is amplified by an amplifier circuitry 116 to provide an amplified exciting signal to the resolver 118. During operation of the motor 112, the resolver 118 outputs a modulated two-phase sin/cos signal to a signal condition circuit 122 which conditions the feedback signal and provides the conditioned signal to the MCU 102 The sin/cos feedback signal is input to the SDADC 124.

In various embodiments, the zero crossing points of the sine and cosine feedback signals are identified using an on-chip comparator circuit, such as comparator module 126. The use of an on-chip comparator provides a fast, efficient, and low-cost solution, without adding CPU load. In various embodiments, the comparator module 126 receives a digitized value of the sine and cosine signals from the SDADC 124, continuously determines which of the sine or cosine feedback signal components has a greater amplitude at any point in time, and uses the signal component (sine or cosine) with the greater amplitude to determine the zero crossing point at that time. In various embodiments, any suitable circuitry or mechanism may be used to determine which of the sine or cosine feedback signal components has a greater amplitude and to determine a more accurate rectify and integration window.

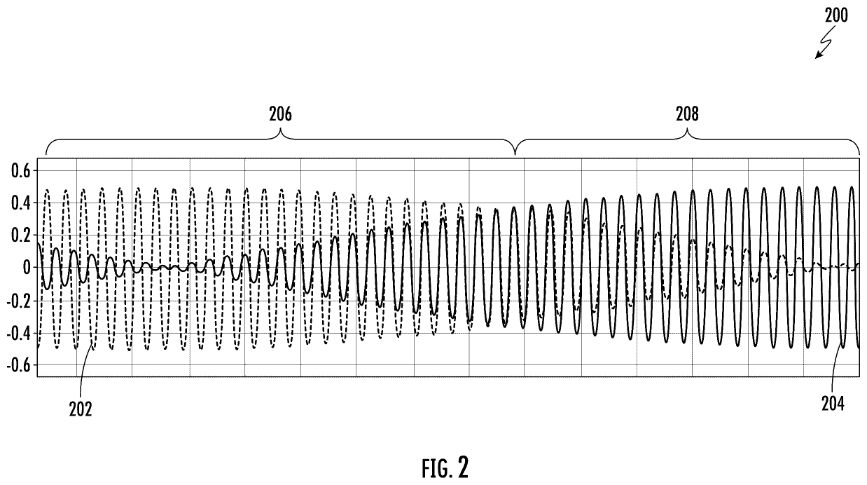

FIG. 2 illustrates an example resolver feedback signal 200 comprising a sine component 202 and a cosine component 204. As seen in FIG. 2, the sine component 202 and the cosine component 204 are 90 degrees out of phase and have the same zero crossing points. As described above, the comparator module 126 continuously (while the motor 112 is operating) determines which of the sine or cosine feedback signal components has a greater amplitude at any point in time. In the example feedback signal of FIG. 2, the sine component 202 is greater than the cosine component 204 during time period 206 and therefore the sine component 202 would be used during time period 206 to determine the zero crossing points of the resolver feedback signal 200. Conversely, in the example feedback signal of FIG. 2, the cosine component 204 is greater than the sine component 202 during time period 208 and therefore the cosine component 204 would be used during time period 208 to determine the zero crossing points of the resolver feedback signal 200.

By using the feedback signal component (sine or cosine) with the greater amplitude to determine the zero crossing points, the zero crossing points can be determined more accurately since the higher amplitude signal component is less likely to be obscured by noise. The output of the comparator circuit is herein termed a sampled feedback signal.

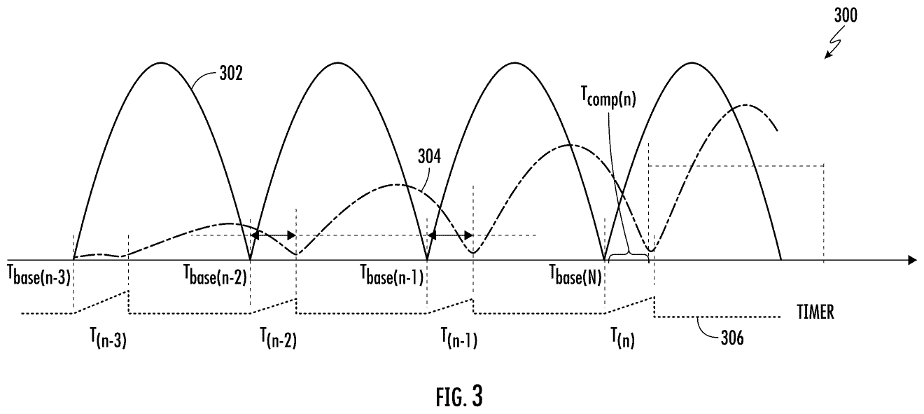

In various embodiments, an amount of time between each zero crossing of the exciting signal and each corresponding zero crossing of the sampled feedback signal is determined, such as by the timer module 128. In various embodiments, any suitable circuitry or mechanism may be used to determine the amount of time between each zero crossing of the exciting signal and each corresponding zero crossing of the sampled feedback signal. In various embodiments, the timer module receives the sampled feedback signal from the comparator module 126 and receives the exciting signal from the GTM 114. In various embodiments, the timer module 128 starts a timer at each zero crossing of the exciting signal and stops the timer at the corresponding zero crossing of the sampled feedback signal. This is seen in FIG. 3 which illustrates an example timing diagram 300 of various embodiments. FIG. 3 illustrates the exciting signal 302 and the sampled feedback signal 304. The phase delay between the exciting signal 302 and the sampled feedback signal 304 is indicated by the horizontal double arrows. Each zero crossing of the exciting signal 302 is indicated by a short vertical line of the same line type as the exciting signal 302, and each zero crossing of the sampled feedback signal 304 is indicated by a short vertical line of the same line type as the sampled feedback signal 304.

An example of the operation of a timer controlled by the timer module 128 is illustrated by line 306. As seen in FIG. 3, at each zero crossing of the exciting signal 302, the timer module 128 starts the timer and at each corresponding zero crossing of the sampled feedback signal 304, the timer module 128 stops the timer. The time of each zero crossing of the exciting signal 302 is designated T_{base}, such that the most recent zero crossing of the exciting signal 302 is designated T_{base(n)}, the immediately preceding zero crossing of the exciting signal 302 is designated T_{base(n-1)}, the next preceding zero crossing of the exciting signal 302 is designated T_{base(n-2)}, the next preceding zero crossing of the exciting signal 302 is designated T_{base(n-3)}, etc. The timer values are designated T, such that the most recent timer value is designated T₍ₙ₎, the immediately preceding timer value is designated T₍ₙ₋₁₎, the next preceding timer value is designated T₍ₙ₋₂₎, the next preceding timer value is designated T₍ₙ₋₃₎, etc.

In various embodiments, a plurality of preceding timer values are obtained (e.g., T₍ₙ₋₃₎, T₍ₙ₋₂₎, T₍ₙ₋₁₎) and filtered, such as by the FIR filter 130, to determine an amount of time (which may be termed the “compensation time” and is designated in FIG. 3 as T_{comp(n)}) that is used to determine the start time of the integration window. In various embodiments, at each zero crossing of the exciting signal 302, a new compensation time is determined. In various embodiments, any suitable number of preceding timer values may be used. For example, a 25 tap FIR filter may be used such that the preceding 25 timer values are filtered to determine each new compensation time. In various embodiments, the start time of each integration window is established by adding T_{comp(n)} to the time of the most recent zero crossing of the exciting signal (T_{base(n)}). In various embodiments, T_{comp(n)} can be dynamically updated to ensure that a more accurate integration window start time continues to be determined.

Using several preceding timer values to determine the compensation time enables embodiments of the present disclosure to obtain a more accurate compensation time value in case noise corrupts one or more of the timer values. In this regard, embodiments of the invention are able to compensate for any phase delay in the feedback signal caused by, for example, temperature variations, and under different operating conditions. While using several preceding timer values means that the determination of the compensation time is not in real time and is slightly delayed, the delay is negligible because the frequency of the exciting signal is so high (typically 10-20 kilohertz). In various embodiments, any suitable circuitry or mechanism may be used to filter the timer values.

In various embodiments, each compensation time is provided to the integration module 132 to enable the integration module 132 to repeatedly determine the start time of each integration window in order to determine the rotor angle θ. The integration module 132 provides the rotor angle to the control loop circuitry 104 for use in controlling the motor 112. Embodiments of the present disclosure are able to nearly eliminate the rotor angle determination error due to phase delay, such as may be due to thermal shift.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitries both leverage use of the same processor(s), memory(ies), circuitry(ies), and/or the like to perform their associated functions such that duplicate hardware is not required for each set of circuitry.

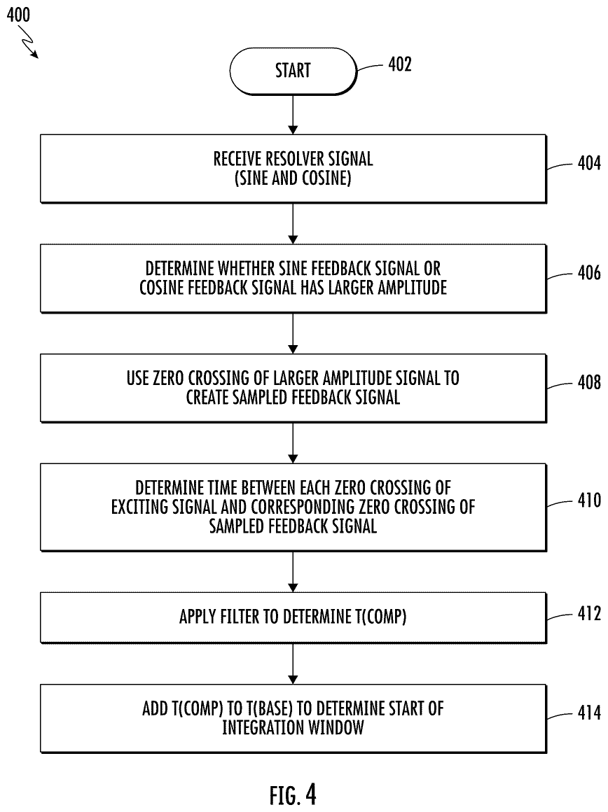

Reference will now be made to FIG. 4, which provides a flowchart illustrating example steps, processes, procedures, and/or operations in accordance with various embodiments of the present disclosure. Various methods described herein, including, for example, example methods as shown in FIG. 4, may provide various technical benefits and improvements. It is noted that each block of the flowchart, and combinations of blocks in the flowchart, may be implemented by various means such as hardware, firmware, circuitry and/or other devices associated with execution of software including one or more computer program instructions. For example, one or more of the procedures described in FIG. 4 may be embodied by computer program instructions, which may be stored by a non-transitory memory of an apparatus employing an embodiment of the present disclosure and executed by a processor in the apparatus. These computer program instructions may direct a computer or other programmable apparatus to function in a particular manner, such that the instructions stored in the computer-readable storage memory produce an article of manufacture, the execution of which implements the function specified in the flowchart block(s).

As described above and as will be appreciated based on this disclosure, embodiments of the present disclosure may be configured as methods, devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Similarly, embodiments may take the form of a computer program code stored on at least one non-transitory computer-readable storage medium. Any suitable computer-readable storage medium may be utilized including non-transitory hard disks, CD-ROMs, flash memory, optical storage devices, or magnetic storage devices.

Having described example systems, apparatuses, computing environments, and user interfaces associated with embodiments of the present disclosure, example flowcharts including various operations performed by the circuits, apparatuses, systems, and/or devices described herein will now be discussed. It should be appreciated that each of the flowcharts depicts an example process that may be performed by one or more of the circuits, apparatuses, systems, and/or devices described herein, for example utilizing one or more of the components thereof. The blocks indicating operations of each process may be arranged in any of a number of ways, as depicted and described herein. In some such embodiments, one or more blocks of any of the processes described herein occur concurrently rather than sequentially. In some such embodiments, one or more blocks of any of the processes described herein occur in-between one or more blocks of another process, before one or more blocks of another process, and/or otherwise operates as a sub-process of a second process. Additionally or alternative, any of the processes may include some or all of the steps described and/or depicted, including one or more optional operational blocks in some embodiments. In regard to the below flowchart(s), one or more of the depicted blocks may be optional in some, or all, embodiments of the disclosure. Optional blocks (if present) are depicted with broken (or “dashed”) lines. Similarly, it should be appreciated that one or more of the operations of each flowchart may be combinable, replaceable, re-ordered, and/or otherwise altered as described herein.

Referring now to FIG. 4, an example flow diagram illustrating an example method 400 for determining a start time of an integration window of a motor resolver in accordance with some embodiments of the present disclosure is illustrated. In some embodiments, the example method 400 may be implemented by an example system described herein, including, but not limited to, the example system 100 described above in connection with FIG. 1.

In the example method shown in FIG. 4, the example method 400 starts at step/operation 402. At step/operation 404, one or more components of a system (such as, but not limited to, the SDADC 124 of the MCU 102 described above in connection with FIG. 1) continuously receives a signal, directly or indirectly, from a resolver of an electric motor (such as, but not limited to, the resolver 118 of the motor 112 described above in connection with FIG. 1). As described above, in various embodiments the signal from the resolver is a two-phase sin/cos signal.

At step/operation 406, one or more components of a system (such as, but not limited to, the comparator module 126 of the MCU 102 described above in connection with FIG. 1) continuously determines whether the sine component of the resolver feedback signal or the cosine component of the resolver feedback signal has a larger amplitude.

At step/operation 408, one or more components of a system (such as, but not limited to, the comparator module 126 of the MCU 102 described above in connection with FIG. 1) continuously creates a sampled feedback signal using the zero crossings of whichever component (sine or cosine) of the resolver feedback signal is determined at step/operation 406 to have a larger amplitude.

At step/operation 410, one or more components of a system (such as, but not limited to, the timer module 128 of the MCU 102 described above in connection with FIG. 1) repeatedly determines the time between each zero crossing of the exciting signal and the corresponding zero crossing of the sampled feedback signal.

At step/operation 412, one or more components of a system (such as, but not limited to, the FIR filter 130 of the MCU 102 described above in connection with FIG. 1) filters the time values obtained at step/operation 410 to determine a compensation time. In various embodiments, the filter coefficient can be flexibly configured to target different system noise.

At step/operation 414, one or more components of a system (such as, but not limited to, the integration module 132 of the MCU 102 described above in connection with FIG. 1) adds the compensation time determined at step/operation 412 to the time of the current zero crossing of the exciting signal to determine the start time of the current integration window. Although not illustrated in FIG. 4, one or more components of a system (such as, but not limited to, the integration module 132 of the MCU 102 described above in connection with FIG. 1) would use the integration window start time determined at step/operation 414 to determine the current rotor angle.

In some embodiments, the example method shown in FIG. 4 continuously repeats as long as the motor is operating.

Some or all of the functionality described herein may be implemented as part of an integrated circuit (IC) (e.g., MCU 102) to perform, for example, one or more functions described herein. The processing elements described herein may include one or more processors, input/output circuitry, data storage media, communications circuitry, and/or other components configured to perform compute operations. In some embodiments, the data storage media may be configured to store information, data, content, applications, instructions, or the like, for enabling the processing elements described herein to carry out various functions. As such, in some embodiments, the processing elements described herein may be referred to as functional logic. The processing elements described herein may be embodied in a number of different ways, for example, in some embodiments, the processing elements described herein may include one or more processing devices configured to perform independently. Additionally or alternatively, in some embodiments, the processing elements described herein may include one or more processor(s) configured in tandem via a bus to enable independent execution of instructions, pipelining, and/or multithreading. The use of the terms “controller,” “processor,” “control circuitry,” and “processing circuitry” should be understood to include a single core processor, a multi-core processor, multiple processors internal to the processing elements described herein, and/or one or more remote or “cloud” processor(s) external to the processing elements described herein.

In an example embodiment, the processing elements described herein may be configured to execute instructions stored in the data storage media or otherwise accessible to the processor. Alternatively or additionally, the processing elements described herein in some embodiments is configured to execute hard-coded functionality. As such, whether configured by hardware or software methods, or by a combination thereof, the processing elements described herein represent an entity (e.g., physically embodied in circuitry) capable of performing operations according to an embodiment of the present disclosure while configured accordingly. Alternatively or additionally, as another example in some example embodiments, when the processing elements described herein is embodied as an executor of software instructions, the instructions specifically configure the processing elements described herein to perform the algorithms embodied in the specific operations described herein when such instructions are executed.

The use of the term “circuitry” as used herein with respect to components of the apparatus should therefore be understood to include particular hardware configured to perform the functions associated with the particular circuitry as described herein. The term “circuitry” should be understood broadly to include hardware and, in some embodiments, software for configuring the hardware. For example, in some embodiments, “circuitry” may include processing circuitry, storage media, network interfaces, input/output devices, and the like.

### Conclusion

Many modifications and other embodiments of the disclosures set forth herein will come to mind to one skilled in the art to which these disclosures pertain having the benefit of teachings presented in the foregoing descriptions and the associated drawings. Although the figures only show certain components of the apparatus and systems described herein, it is understood that various other components may be used in conjunction with the system. Therefore, it is to be understood that the disclosures are not to be limited to the specific embodiments disclosed and that modifications and other embodiments are intended to be included within the scope of the appended claims. Moreover, the steps in the method described above may not necessarily occur in the order depicted in the accompanying diagrams, and in some cases one or more of the steps depicted may occur substantially simultaneously, or additional steps may be involved. Although specific terms are employed herein, they are used in a generic and descriptive sense only and not for purposes of limitation.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. Accordingly, the scope of protection is not limited by the description set out above.

Additionally, the section headings used herein are provided for consistency with the suggestions under 37 C.F.R. 1.77 or to otherwise provide organizational cues. These headings shall not limit or characterize the disclosure(s) set out in any claims that may issue from this disclosure.

While this detailed description has set forth some embodiments of the present disclosure, the appended claims cover other embodiments of the present disclosure which differ from the described embodiments according to various modifications and improvements. For example, the appended claims can cover any form of system, device, integrated circuit, or method which uses a resolver for determining an angular position of an electric motor, such as for automotive traction inverter applications.

Within the appended claims, unless the specific term “means for” or “step for” is used within a given claim, it is not intended that the claim be interpreted under 35 U.S.C. 112, paragraph 6.

What is claimed is:

1. An integrated circuit for determining a start time of an integration window of a motor resolver, the integrated circuit comprising:
a timer module for repeatedly determining a plurality of timer values, each timer value corresponding to an elapsed time between a zero crossing of an exciting signal provided to a resolver of an electric motor and a corresponding immediately succeeding zero crossing of a feedback signal from the resolver;
a filter module for repeatedly determining, based on a most recent sub-plurality of the timer values, a compensation time corresponding to a delay between the exciting signal and the feedback signal; and
an integration module for repeatedly determining a start time of an integration window by adding a most recently determined compensation time to a time of a most recent zero crossing of the exciting signal.

2. The integrated circuit of claim 1, further comprising:
a comparator module for continuously determining an amplitude of a sine component of the feedback signal and a cosine component of the feedback signal and continuously producing a sampled feedback signal using the sine component when the amplitude of the sine component is larger than the amplitude of the cosine component and using the cosine component when the amplitude of the cosine component is larger than the amplitude of the sine component;
wherein the timer module uses the sampled feedback signal to identify zero crossings of the feedback signal and determine the plurality of timer values.

3. The integrated circuit of claim 2, further comprising:
an analog-to-digital converter module to receive the feedback signal from the resolver and provide a digital version of the sine component and a digital version of the cosine component to the comparator module.

4. The integrated circuit of claim 1, wherein the integration module determines a rotor angle within each integration window.

5. The integrated circuit of claim 1, wherein the filter module comprises a finite impulse response (FIR) filter.

6. The integrated circuit of claim 5, wherein the FIR filter comprises 25 taps.

7. A processing system for determining a start time of an integration window of a motor resolver, the processing system comprising:
a timer module for repeatedly determining a plurality of timer values, each timer value corresponding to an elapsed time between a zero crossing of an exciting signal provided to a resolver of an electric motor and a corresponding immediately succeeding zero crossing of a feedback signal from the resolver;
a filter module for repeatedly determining, based on a most recent sub-plurality of the timer values, a compensation time corresponding to a delay between the exciting signal and the feedback signal; and
an integration module for repeatedly determining a start time of an integration window by adding a most recently determined compensation time to a time of a most recent zero crossing of the exciting signal.

8. The processing system of claim 7, further comprising:
a comparator module for continuously determining an amplitude of a sine component of the feedback signal and a cosine component of the feedback signal and continuously producing a sampled feedback signal using the sine component when the amplitude of the sine component is larger than the amplitude of the cosine component and using the cosine component when the amplitude of the cosine component is larger than the amplitude of the sine component;
wherein the timer module uses the sampled feedback signal to identify zero crossings of the feedback signal and determine the plurality of timer values.

9. The processing system of claim 8, further comprising:
an analog-to-digital converter module to receive the feedback signal from the resolver and provide a digital version of the sine component and a digital version of the cosine component to the comparator module.

10. The processing system of claim 7, wherein the integration module determines a rotor angle within each integration window.

11. The processing system of claim 7, wherein the filter module comprises a finite impulse response (FIR) filter.

12. The processing system of claim 11, wherein the FIR filter comprises 25 taps.

13. A method for determining a start time of an integration window of a motor resolver, the method comprising:
repeatedly determining a plurality of timer values, each timer value corresponding to an elapsed time between a zero crossing of an exciting signal provided to a resolver of an electric motor and a corresponding immediately succeeding zero crossing of a feedback signal from the resolver;
repeatedly determining, based on a most recent sub-plurality of the timer values, a compensation time corresponding to a delay between the exciting signal and the feedback signal; and
repeatedly determining a start time of an integration window by adding a most recently determined compensation time to a time of a most recent zero crossing of the exciting signal.

14. The method of claim 13, further comprising:
continuously determining an amplitude of a sine component of the feedback signal and a cosine component of the feedback signal and continuously producing a sampled feedback signal using the sine component when the amplitude of the sine component is larger than the amplitude of the cosine component and using the cosine component when the amplitude of the cosine component is larger than the amplitude of the sine component;
wherein zero crossings of the feedback signal are identified and the plurality of timer values are determined using the sampled feedback signal.

15. The method of claim 14, further comprising:
receiving the feedback signal from the resolver and providing a digital version of the sine component and a digital version of the cosine component.

16. The method of claim 13, further comprising:
determining a rotor angle within each integration window.
